(19) United States
(12) Patent Application Publication
(10) Pub. No.: US 2014/0236935 A1
(43) Pub. Date: Aug. 21, 2014

(54) Service Provider Matching

(71) Applicant: Thursday Market, Inc., Seattle, WA (US)

(72) Inventors: Eric Doebele, Seattle, WA (US); Jack Phan, Mercer Island, WA (US)

(73) Assignee: Thursday Market, Inc., Seattle, WA (US)

(21) Appl. No.: 14/185,707

(22) Filed: Feb. 20, 2014

Related U.S. Application Data
(60) Provisional application No. 61/767,146, filed on Feb. 20, 2013.

(51) Int. Cl. G06F 17/30

(52) U.S. Cl. CPC G06F 17/30864
USPC 707/723; 707/769

(57) ABSTRACT

Embodiments that relate to matching a requester with a service provider are disclosed. In one example, a method for matching a requester with a service provider that provides services in a category may include receiving from the requester a search request including the category. At least one social network connection between the requester and an endorser of the service provider is identified. The method includes determining that the endorser has at least one endorsement connection with the service provider. Based on the social network connection and the endorsement connection, the requester is matched with the service provider. Based on matching the requester with the service provider, service provider information corresponding to the service provider is provided to a requester computing device.

### CROSS REFERENCE TO RELATED APPLICATION

This application claims priority to U.S. Provisional Patent Application Ser. No. 61/767,146, filed Feb. 20, 2013 and entitled SERVICE PROVIDER MATCHING, the entire disclosure of which is herein incorporated by reference.

### BACKGROUND

Websites directed to searching for local services and related online directories may aggregate consumer reviews, ratings and other information related to service companies. Some systems may provide a search platform that enables users to search for service providers using basic information, such as a type or category of service and a location of the service provider relative to the user's location. Accordingly, the search algorithms of such systems are limited to using such basic information to match service providers to a user's search request.

The search results from these systems may be presented to the user with previous customer reviews, grades, and/or other measures of satisfaction level. Many times, however, such reviews and grades are from previous customers or other sources who are unknown to the user. Furthermore, fake positive reviews are not uncommon on these websites. Accordingly, evaluating the value and trustworthiness of reviews and ratings provided by unknown sources can prove challenging.

Some websites and directories also may provide insufficient relevant information to help users distinguish among choices. Some websites may further require users to visit multiple websites to make a decision regarding selecting a company. Online lead generator services may also provide recommendation services that match a service company to a user. However, such lead generator services often require the user to fill out long lead generation forms that include numerous questions and requests for information regarding the services desired by the user. Further, the leads generated by such services may be relatively low in quality, resulting in a less than satisfactory user experience. Additionally, the typical user experience provided by lead generator services does not lend itself to access via mobile devices.

### BRIEF DESCRIPTION OF THE FIGURES

FIG. 1 is a schematic view of an embodiment of a matching system for matching a requester with a service provider.

FIG. 2 is a schematic view of an embodiment of a user interface displayed on a requester's computing device and including category and zip code search boxes.

FIG. 3 is a schematic view of an embodiment of a user interface displayed on a requester's computing device and including search results including Company A.

FIG. 4 is a schematic view of an embodiment of a user interface including a service provider profile of Company A.

FIG. 5 is a schematic view of an embodiment of a user interface including a provider portal and showing a dashboard tab.

FIG. 6 is a schematic view of an embodiment of a user interface including the provider portal of FIG. 5 and showing a clients tab.

FIG. 7 is a schematic view of an embodiment of a user interface including the provider portal of FIG. 5 and showing an ads tab.

FIG. 8 is a schematic view of an embodiment of a user interface including the provider portal of FIG. 5 and showing a messages tab.

FIG. 9 is a schematic view of an embodiment of a user interface including the provider portal of FIG. 5 and showing an endorsements tab.

FIGS. 10A, 10B, and 10C are a flow chart of a method for matching a requester with a service provider according to an embodiment of the present disclosure.

FIG. 11 is a flow chart of a method for matching a requester with a service provider according to another embodiment of the present disclosure.

FIG. 12 is a simplified schematic illustration of an embodiment of a computing system.

### DETAILED DESCRIPTION

Aspects of this disclosure will now be described by example and with reference to the illustrated embodiments listed above. Components, process steps, and other elements that may be substantially the same in one or more embodiments are identified coordinately and are described with minimal repetition. It will be noted, however, that elements identified coordinately may also differ to some degree. It will be further noted that the drawing figures included herein are schematic and generally not drawn to scale. Rather, the various drawing scales, aspect ratios, and numbers of components shown in the figures may be purposely distorted to make certain features or relationships easier to see.

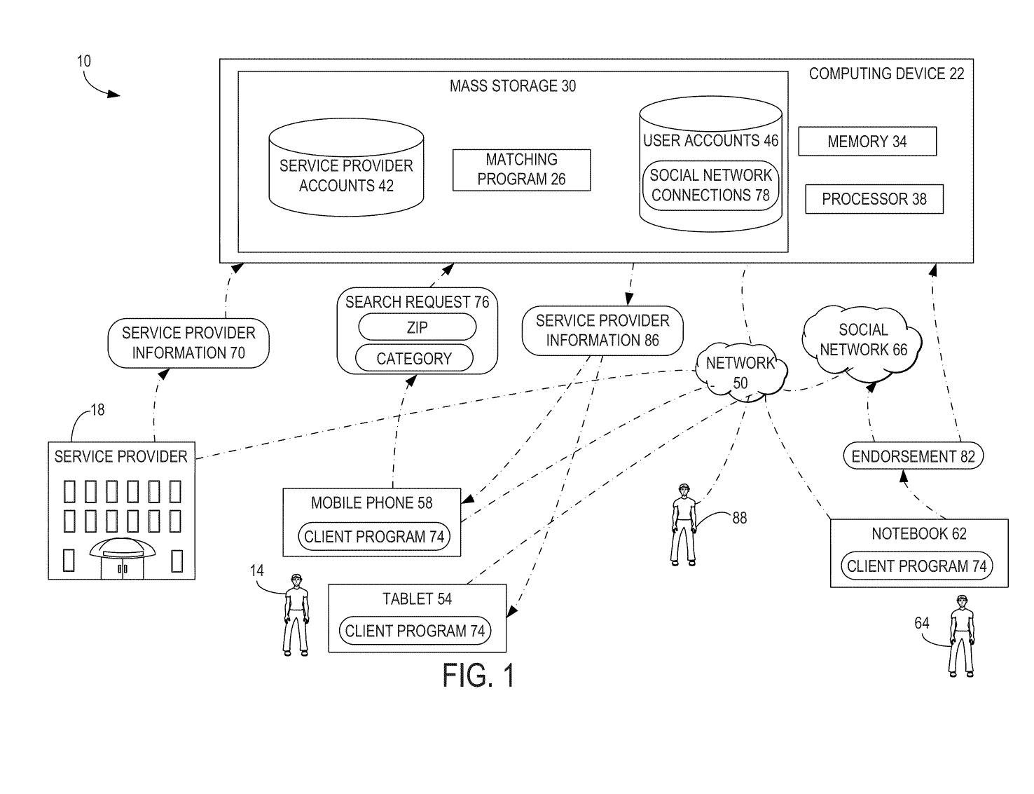

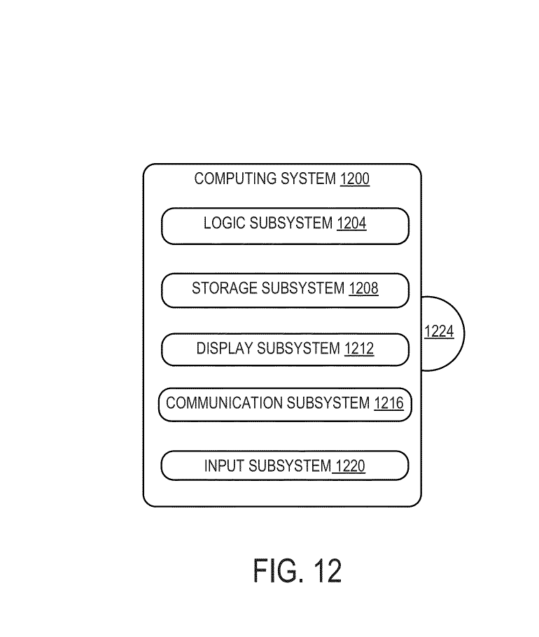

FIG. 1 shows a schematic view of an embodiment of a matching system 10 for matching a requester 14 with a service provider 18. In one embodiment, the matching system 10 comprises a matching computing device 22 that includes a matching program 26 in mass storage 30. As explained in more detail below, the matching program 26 may include one or more search engines for receiving search requests from requesters and searching requester information and service provider information for matching service providers. In different embodiments, the matching computing device 22 may take the form of a server, network computer, desktop computing device, mobile computing device such as a smart phone, laptop, notebook or tablet computer, home entertainment computer, or other suitable type of computing device. Additional details regarding the components and computing aspects of the matching computing device 22 are described in more detail below with reference to FIG. 12.

The matching computing device 22 includes mass storage 30, memory 34, and a processor 38. Programs stored in mass storage 30 may be executed by the processor 38 using memory 34 to achieve various functions described herein. Mass storage 30 may include an operating system and, as described in more detail below, a service provider account database 42 and a user account database 46. It will also be appreciated that in some examples, one or more of the matching program 26, service provider account database 52, and user account database 46 may be stored remotely from the matching computing device 22, such as on a remote server, and may be accessed via a network 50.

As described in more detail below, the matching system 10 may be communicatively connected with one or more other computing devices via network 50. In the example shown in FIG. 1, matching computing device 22 is communicatively connected with a tablet computer 54 and mobile phone 58 associated with a requester 14, with such computing devices generally referred to as requester computing devices. Matching computing device 22 also may be communicatively connected with a notebook computer 62 associated with a previous customer and/or endorser 64 of a service provider, with such computing device generally referred to as a customer/endorser computing device. It will be appreciated that the matching system 10 may be communicatively connected with a variety of other types of computing devices including, but not limited to, wearable display devices, desktop PCs, etc. Additional details regarding the components and computing aspects of the tablet computer 54, mobile phone 58, notebook computer 62 and other such computing devices are described in more detail below with reference to FIG. 12.

The matching computing device 22 may also be communicatively connected to one or more social networking services, such as social network 66. Social networking services may include, but are not limited to, Facebook, Google+, tumblr, LinkedIn, Twitter, or any other online service, platform, or community that facilitates the building of social networks and/or social relationships among individuals. The network 50 may take the form of a local area network (LAN), wide area network (WAN), wired network, wireless network, personal area network, or a combination thereof, and may include the Internet.

As described in more detail below, requesters and/or service providers may utilize and interact with the matching system 10 via a matching system graphical user interface (GUI). For example, tablet computer 54, mobile phone 58 and notebook 62 each include a display on which the matching system GUI and corresponding screens may be displayed. In one example the matching program 26 may generate the matching system GUI in the form of a web page that is rendered by a browser of a computing device. In other examples, a client program 74 on a requester or service provider computing device may generate the matching system GUI on the display of the computing device.

The service provider account database 42 may include information related to service providers that have registered to become a member of a matching service provided by the matching system 10. Such service provider information may include, but is not limited to, the categories and/or types of services offered, locations and other information regarding previous customers, recommendations, endorsements, images, billing rates, payment information, advertisements, coupons, offers, listings for services, other company information, and the like. Such service provider information may be received from sources that include, but are not limited to, the service provider, customers and/or rating services, messages from customers, commercial information databases, etc. The categories of services may include, but are not limited to, home improvement, professional services such as doctors and dentists, mortgage broker services, wedding and entertainment services, realtor services, automotive services, computer repair services, moving services, cleaning services, etc., and may also include one or more levels of sub-categories within each category. Such information may be compiled into a service provider profile for each service provider that may store in the service provider account database 42.

The user accounts database 46 may include information related to users, such as requester 14, that have registered to be a member of the matching service. Such user information may include, but is not limited to, social network information such as social network connections, friends, individuals and/or businesses followed, service provider endorsements and/or recommendations provided by the user, service provider endorsements and/or recommendations provided by friends or other social network connections of the user, and service provider endorsements and/or recommendations provided by friends of friends of the user. Such information may also include, but is not limited to, service provider endorsements and/or recommendations provided by the user via the matching system 10, address and location information of the user, information regarding neighbors of the user, friends and other social connections of the user, payment information, search history, reviews provided by the user, favorite service providers, subscription information, linked social networking services and other accounts, contact information and preferences, etc. Such user information may be received from sources including, but not limited to, the user, social networks, online databases, commercial information services, service providers, social network connections of the user, etc.

In one example shown in FIG. 1, service provider 18 may be registered with the matching system 10 and may provide service provider information 70 to the matching program 26 for including in the profile of the service provider. Additional service providers registered with the system 10 may also provide service provider information to the matching program 26 for their profiles. As noted above, in some examples information regarding a service provider may also be obtained from third party sources. For example, service provider information relating to a service provider that is not registered with the matching system 10 may be imported from other data sources. Subsequently, the service provider may be invited to ‘activate’ its listing by confirming that the information is correct and adding additional information. In this manner, a database of service providers and their associated information is maintained.

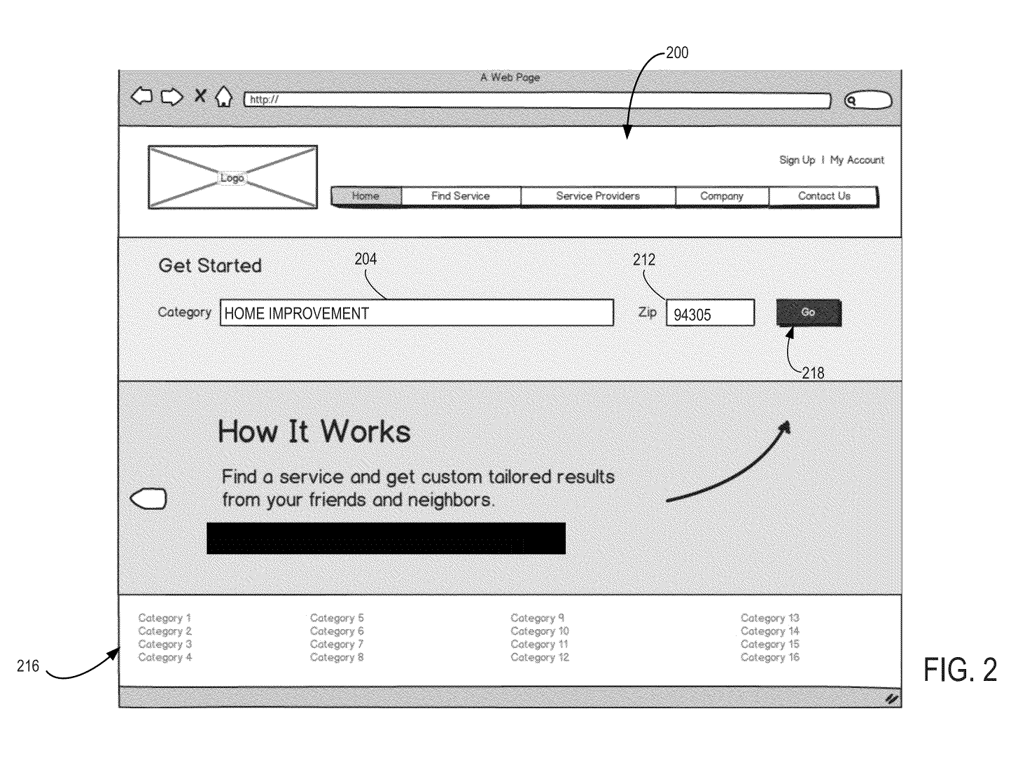

Example use case scenarios will now be described with reference to FIG. 1 and the user interface example screens shown in FIGS. 2-9. It will be appreciated that the user interface examples may comprise a web page rendered by a browser or a screen display generated by an application, such as client program 74 on a computing device. In one example, a requester 14 may be registered with the matching system 10 and may desire to locate a service provider that performs home improvement services. As shown in FIG. 1, the requester may have a mobile phone 58 that includes a client program 74 that may communicate with the matching program 26. In one example, the client program 74 may comprise an application that may send search request and other information to the matching program 26, and receive and render for display search results including service provider information from the matching program 26. In another example, the client program 74 may comprise a web browser that retrieves, presents and traverses information resources or other content via the matching program 26.

With reference now to the example user interface 200 shown in FIG. 2, the user may enter the category search term “HOME IMPROVEMENT” in the category search box 204 and the zip code search term “94305” in the zip code search box 212. Various example categories 216 may also be displayed in the user interface 200. In some examples, two or more categories may be entered in the category search box 204. As noted above, a wide variety of categories and sub-categories related to various service offerings may be displayed and/or made available for searching. It will also be appreciated that in other examples only a category search term may be entered and searched. In some examples, the zip code and/or other information related to the requester 14 may be provided or retrieved by the client program 74 and/or the matching program 26 for use in performing a search. It will also be appreciated that additional and/or different search boxes corresponding to additional and/or different types of search terms and information, including but not limited to keywords, may also be provided in the user interface 200.

Upon selecting the “Go” button 218, in this example the category and zip code search terms are provided in a search request 76 to the matching program 26. In some examples, regardless of the search terms entered by the requester 14, additional information related to the requester 14 may be provided with the search request 76. Upon receiving the search request 76, the matching program 26 accesses the service provider account database 42 and identifies one or more potentially matching service providers that provide services within or otherwise related to the category identified by the category search term.

Advantageously, the matching program 26 also identifies one or more social network connections 78 between the requester 14 and one or more previous customers or endorsers of each of the potentially matching service providers. It will be appreciated that an endorser also may be a previous customer or may not be a previous customer of a service provider she or he is endorsing. For example, the matching program 26 may identify a social network connection between the requester 14 and a previous customer/endorser 64. It will be appreciated that the social network connections 78 of requester 14 may be stored in the user accounts database 46, and may be received by the matching system 10 from the requester, a social connection of the requester, and/or one or more social networks. It will also be appreciated that the previous customer/endorser 64 may or may not be a previous customer of a potentially matching service provider. In some examples, the previous customer/endorser 64 may be someone who knows the service provider and has endorsed the service provider, but has not necessarily hired or used them in the past. Examples might include vendors of the service provider, associates of the service provider, friends of the service provider, etc. In other examples, a previous customer of a service provider may not be an endorser of the service provider.

The matching program 26 may then determine whether the customer/endorser 64 has one or more endorsement connections 82 with the service provider 18. Endorsement connections may be defined as a rating, recommendation, indication of interest or approval, or other connection that indicates a positive experience or opinion of a customer or other individual with respect to a service provider. For clarity, an endorser is a customer or other individual who has an endorsement connection with a service provider. One example of an endorsement connection comprises an endorsement of a service provider that is provided to the matching system 10 by a customer. Such an endorsement connection is referred to herein as a direct endorsement connection. Other examples of endorsement connections include endorsements provided to other social networks and/or communities, including but not limited to liking on Facebook, following on Twitter, following on LinkedIN, following on Google+, etc. These other endorsement connections that are provided to services other than the matching service provided by the matching system 10 are referred to herein as indirect endorsement connections.

Where the previous customer/endorser 64 has one or more endorsement connections 82 with the service provider 18, the matching program 26 may match the requester 14 with the service provider based at least in part on such endorsement connections and on the one or more social network connections 78 between the requester and the previous customer/endorser. And based on this matching, the matching program 26 provides search results including service provider information 86 related to service provider 18 to a requester computing device associated with the requester 14.

Advantageously, in this example the matching system 10 utilizes social network connections 78 of the requester 14 to match the requester 14 with service provider 18. Furthermore, because the requester 14 has a social connection with previous customer/endorser 64, the requester can use her knowledge of and relationship with the customer/endorser, in combination with the customer/endorser's endorsement of the service provider 18, to better evaluate the service provider. Given this social connection, the requester 14 also gains greater confidence in the reliability and trustworthiness of the endorsement and other review and rating information provided by previous customer/endorser 64. Thus, by utilizing social network connections of the requester 14 in this manner, the matching system 10 generates and provides more useful and trustworthy search results to the requester 14.

In one example, the requester 14 may send the search request 76 from the mobile phone 58. The matching program 26 may send the service provider information 86 to the mobile phone 58. In another example, the matching program 26 may send the service provider information 86 to the tablet 54 instead of the mobile phone 58. For example, the matching program 26 may determine that the requester 14 is currently using the tablet 54, and therefore may receive the service provider information more quickly at the tablet. In another example, the matching program 26 may send the service provider information 86 to both the mobile phone and the tablet 54. In other examples the service provider information may also be sent to additional computing devices associated with the requester 14.

In some examples, the matching program 26 may determine a trust level of each endorsement connection. The matching program 26 may weight each endorsement connection according to its trust level, and may utilize such weights in generating, ranking and/or providing the search results. In one example, endorsements provided from previous customers or others directly to the matching system 10 (i.e., direct endorsement connections) may be weighted heavier than endorsements provided to other services (i.e., indirect endorsement connections). By being weighted heavier, the ranking or prominence of the service providers that correspond to such endorsements may be increased in search results provided to a requester. Similarly, endorsements from different sources may be weighted differently according to a trust level associated with the source. In some examples, endorsements of different types may be weighted differently according to the trust level associated with that type of endorsement.

Advantageously, in this manner the matching system 10 matches requesters with service providers based at least in part on endorsements of those service providers provided by friends and other social network connections of the requester. The total number of endorsements and/or the number of network endorsements may also be used by the matching system 10 to match requesters with service providers. As described in more detail below, network endorsements include endorsements from both first-degree connections, such as friend 88, and second-degree connections of requester 14. For example, the matching system 10 may determine those service providers having at least a predetermined number of total endorsements or at least a predetermined number of network endorsements. Subsequently, only those service providers having at least a predetermined number of total endorsements or network endorsements may be provided to the requester 14. Accordingly, a requester may feel more confident in relying on an endorsement of a service provider that is provided by a social network connection, as the requester already has a social relationship or connection with that person.

In another example, the requester 14 may have a social network connection with a friend 88 of the requester. The friend 88 may have a social network connection to the previous customer/endorser 64. In other words, the requester 14 has a second-degree connection to the previous customer/endorser 64. As noted above the previous customer/endorser 64 has one or more endorsement connections 82 with the service provider 18. In this example, the matching program 26 matches the requester 14 with the service provider 18 based on the second-degree connection of the requester 14 to the previous customer/endorser 64. Based on this matching, the matching program 26 provides search results including service provider information 86 to a computing device associated with the requester 14. In this example, the endorsement from second-degree connection previous customer/endorser 64 may be included in a “Network Endorsements” group that includes endorsements from both first-degree connections, such as friend 88, and second-degree connections. It will be appreciated that the friend 88 may or may not have an endorsement connection to the service provider 18.

In other examples, the matching program 26 may match a requester with a service provider based only on identifying a social network connection between the requester and a previous customer of the service provider, without considering whether the customer has an endorsement connection with the service provider.

In another example, the matching program 26 may determine a location of the requester 14. Such location may be determined, for example, by accessing the requester's user account information, or by geo-locating a computing device of the requester 14, such as the tablet 54 or mobile phone 58. Any suitable geo-locating technique or method may be used, such as using longitude and latitude data, GPS systems, WiFi signals, etc.

The matching program 26 may identify at least one previous customer of the service provider 18 who is located within a predetermined region associated with the location of the requester 14. Any suitable predetermined region may be utilized including, but not limited to, a neighborhood, zip code, city, distance from the requester's location, etc. Based on the location of the requester 14 and identifying at least one customer of the service provider who is located within the predetermined region, the matching program matches the requester with the service provider 18. And based on matching the requester 14 with the service provider 18, the matching program 26 provides service provider information 86 to a computing device associated with the requester 14.

In one example, the matching program 26 may weight a service provider more favorably in the search results as the number of previous customers located within the predetermined region increases. In another example, the matching program 26 may utilize a threshold that corresponds to a minimum number of previous customers located within the predetermined region that is needed to include the service provider in the search results.

Advantageously, in this manner the matching system 10 utilizes the proximity of previous customers to the requester 14 to match the requester 14 with service provider 18. Accordingly, by generating and/or ranking search results based at least in part on the proximity of previous customers to the requester 14, the matching system 10 may provide search results that provide the requester with more service provider information that corresponds to previous customers nearest to the requester's location.

In some examples, the matching program 26 may match the requester 14 with one or more service providers using a combination of identifying social network connections between the requester and a previous customer of the service provider, and identifying at least one customer of the service provider who is located within a predetermined region associated with the location of the requester.

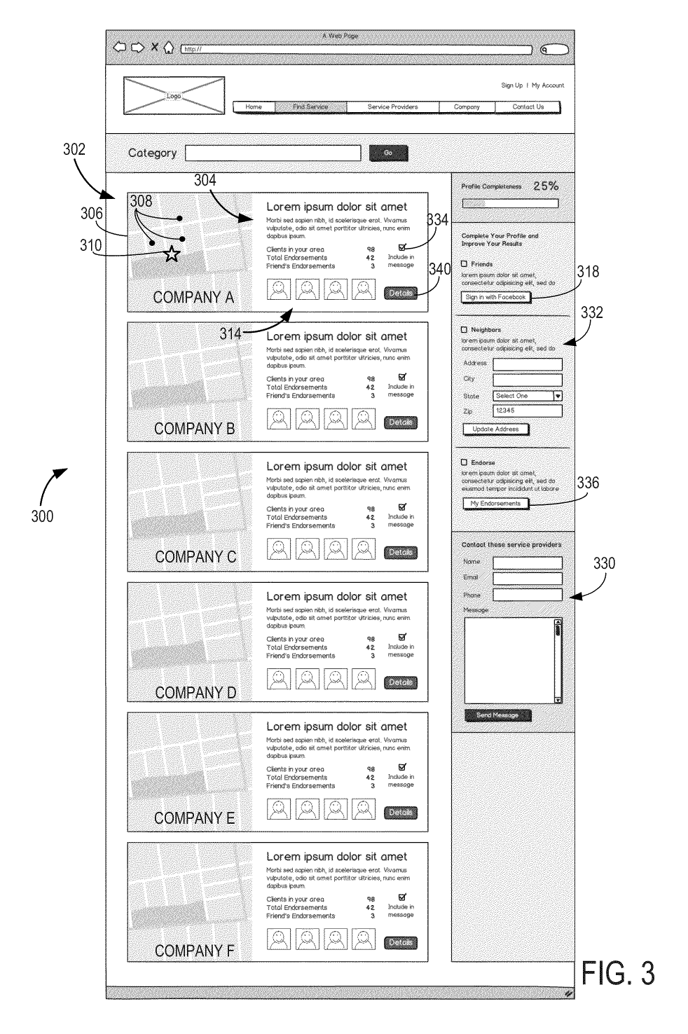

With reference now to FIG. 3, an embodiment of a search results user interface screen including search results 300 is illustrated. The search results 300 may include one or more snapshots of service providers with which the requester 14 was matched. Each snapshot in the search results may include selected service provider information 86 for that service provider. With reference to the snapshot 302 for Company A, selected service provider information and/or other content related to Company A may be displayed in an ad header 304. It will be appreciated that in FIG. 3 the text illustrated in the ad header 304, in the other ad headers for Companies B-F, and in other portions of the user interface screen is merely placeholder text. For example, where Company A is a painting company, the text “Lorem ipsum dolor sit amet” may be replaced with a tag phrase, such as “We specialize in residential painting.”

In some examples, Company A may create and store multiple ad headers that are customized to correspond to particular categories, keywords, and/or other parameters of a search request. For example, upon matching Company A to the requester's search request for Home Improvement services, the matching program 26 may select a designated Home Improvement ad header from among multiple ad headers associated with Company A.

The snapshot may provide a description of the service offered and a number of clients or customers in the requester's area. Each snapshot in the search results may also include a map 306 that includes indicators 308 showing one or more locations of previous customers of that service provider. The map 306 may be the same, larger than, or smaller than a predetermined region that may be used in generating the search results. The requester's location 310 may be indicated on the map 306, and may be substantially centered on the map.

Each snapshot may further include a number of Total Endorsements of that service provider. The Total Endorsements may include one or more of the following: endorsements from previous customers, endorsements from parties who have not been customers, endorsements from parties with social network connections to the requester, endorsements from parties with no social network connections to the requester, endorsements from parties that are located within a predetermined region associated with the location of the requester 14, and endorsements from parties that are not located within the predetermined region. Each snapshot may further include a number of Friend's Endorsements of that service provider that were provided by parties with a social network connection to the requester 14.

In some examples, images 314 corresponding to the parties with a social network connection to the requester and who have an endorsement connection to the service provider may also be provided. In some examples, the images 314 may comprise avatars or other personal indicators of such parties that are retrieved from a social network 66.

To improve a requester's search results, the requester may sign into the matching service provided by matching system 10 by selecting button 318 to sign into the service via a social network 66 login. In this manner, the matching service may pull requester social network connections 78 from the social network 66 and add such connections to the requester's profile stored in user accounts database 46. Location information regarding neighbors of the requester may also be added in area 322. The requester may select button 336 to view, modify and/or add to the requester's endorsement connections.

In area 330, the requester may send an inquiry to a service provider in the form of an email, text message, instant message, or other form of communication. Additionally, within each service provider snapshot, the requester may select a message selector, such as box 334, to add that service provider to an email message. Advantageously, two or more message selectors may be selected to conveniently add multiple service providers to a single email message, such as a request for quote.

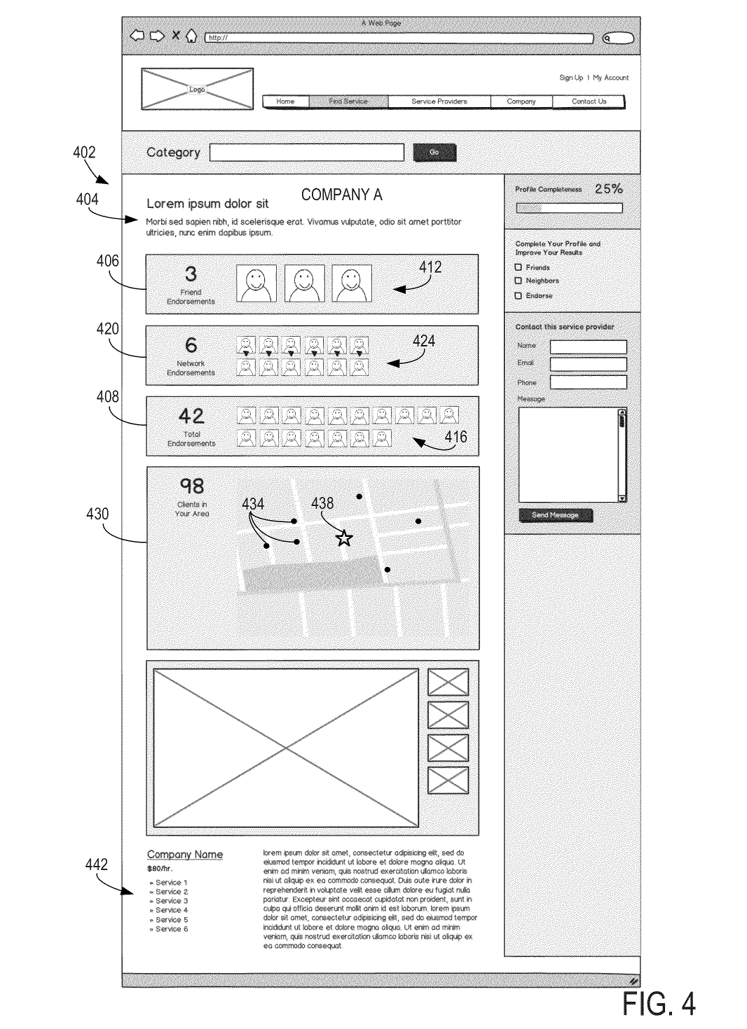

A requester may select a Details button 340 to display a service provider profile page 402, an example of which is shown in FIG. 4. The profile page 402 may include an advertisement region 404 which may include a coupon or other marketing communication. The number of Friend Endorsements may be shown in a Friend Endorsements region 406, and the number of Total Endorsements may be shown in a total Endorsements region 408. In some examples, images 412 of each friend endorser also may be provided in the Friend Endorsements region 406. In some examples, images 416 of each endorser in the Total Endorsements region 408 also may be provided.

In some examples, a number of network endorsements may also be displayed in a Network Endorsements region 420. In one example, network endorsements may include endorsements provided by first-degree and second-degree social network connections of the requester, as described above. In some examples, images 424 of each network endorser also may be provided in the Network Endorsements region 420.

The profile page 402 may also include an expanded map 430 that includes indicators 434 showing one or more locations of previous customers of that service provider. The requester's location 438 may be indicated on the map 414, and may be substantially centered on the map. The map 430 may be the same, larger than, or smaller than the predetermined region. The profile page 402 may include additional selected service provider information 442 relating to that service provider, including images and other content.

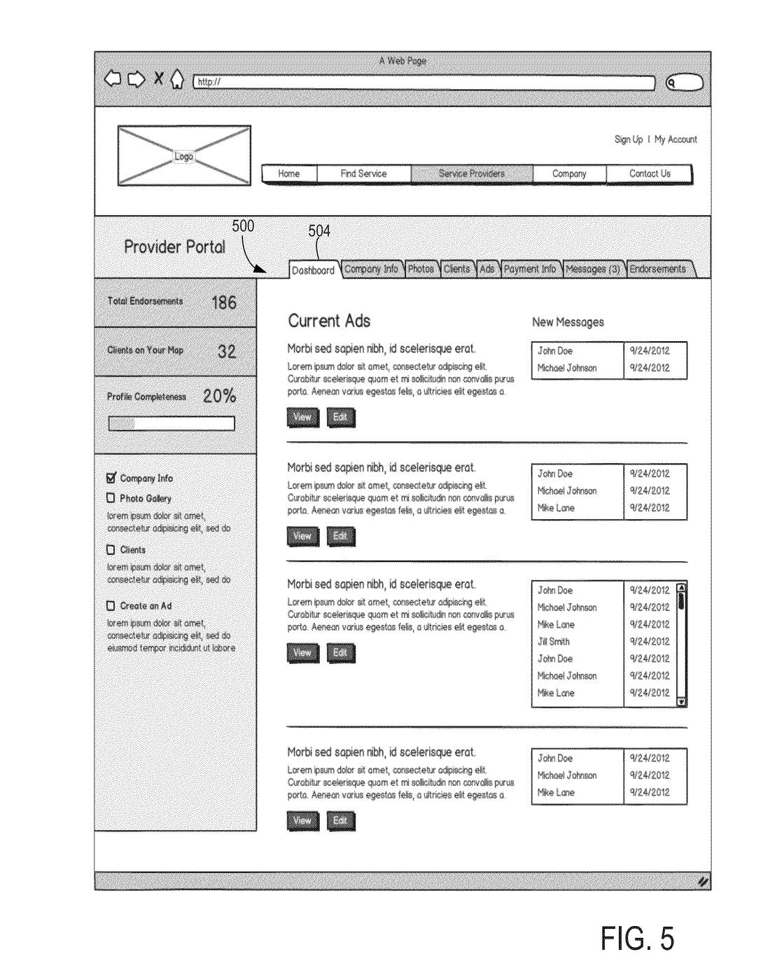

FIG. 5 is a schematic view of an embodiment of the user interface including a provider portal screen 500 and showing contents of a dashboard tab 504. A service provider may access the provider portal screen 500 to manage various aspects of the service provider's account with the matching system 10. The dashboard tab 504 may provide an indication of the number of endorsements received by the service provider, the number of customer locations provided to the matching system 10, and a profile completeness measure. The dashboard tab may also enable the service provider to access current ads, create new ads, and view new messages received from current and/or prospective customers.

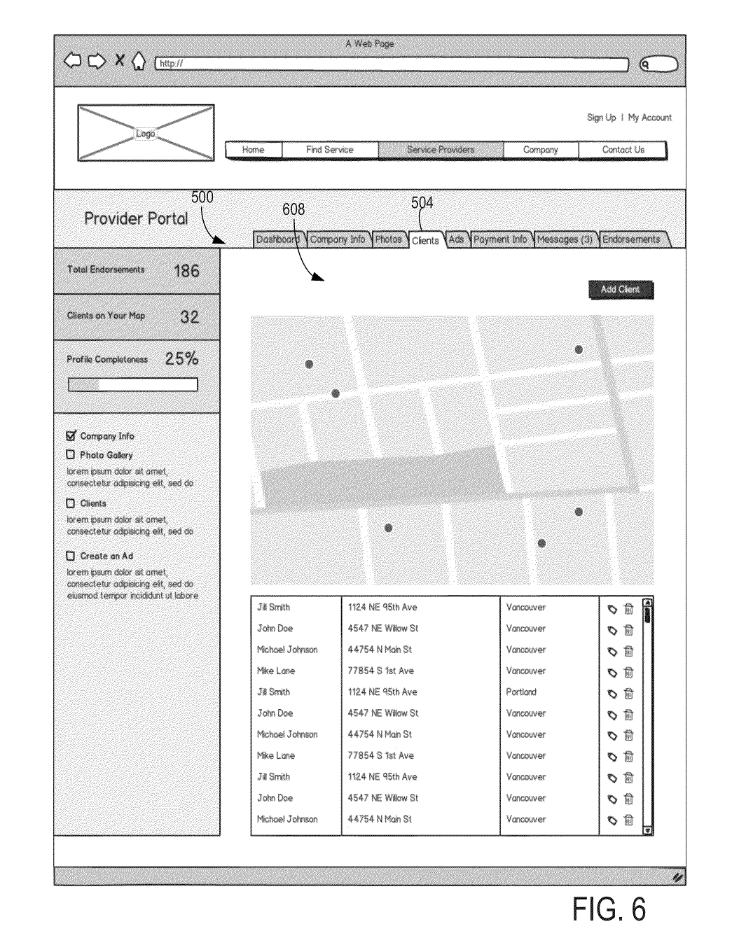

FIG. 6 is a schematic view of an embodiment of the user interface including the provider portal screen 500 of FIG. 5 and showing contents of a clients tab 604. The clients tab 604 may include a map 608 including indicators showing the locations of current and previous customers. Names, addresses, project description, and other customer information for each customer may also be displayed. In some examples, each map indicator may be linked to corresponding customer information.

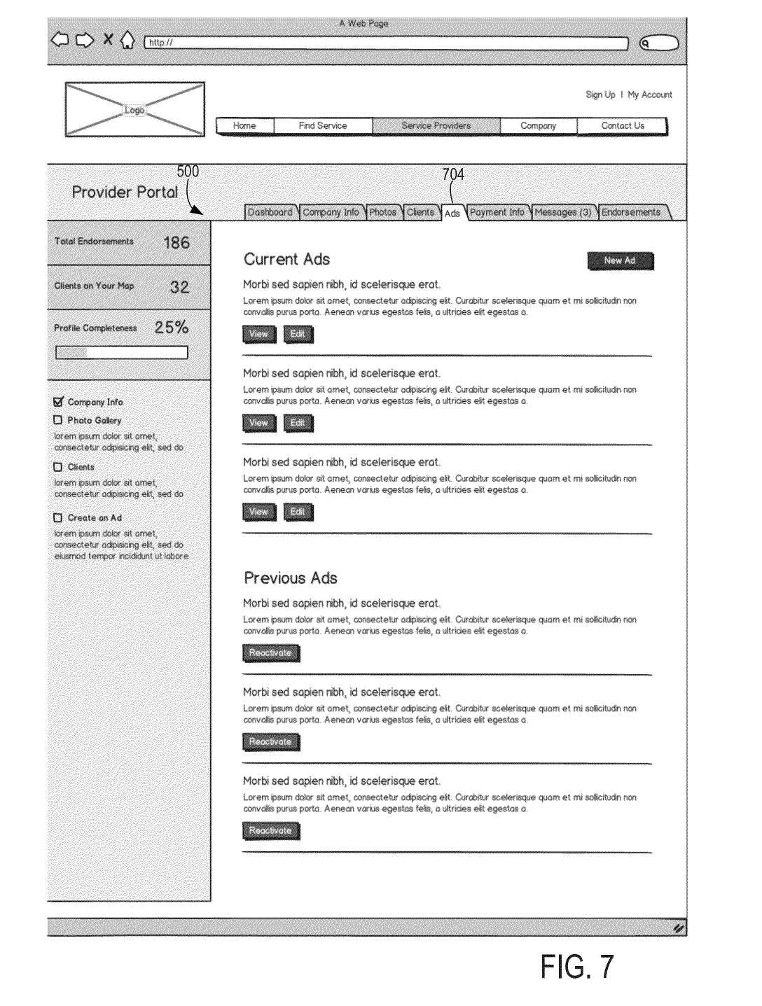

FIG. 7 is a schematic view of an embodiment of the user interface including the provider portal screen 500 of FIG. 5 and showing an ads tab 704. The ads tab 704 may enable a service provider to view and edit current advertisements and previous advertisements. A service provider may also create a new ad from the ads tab.

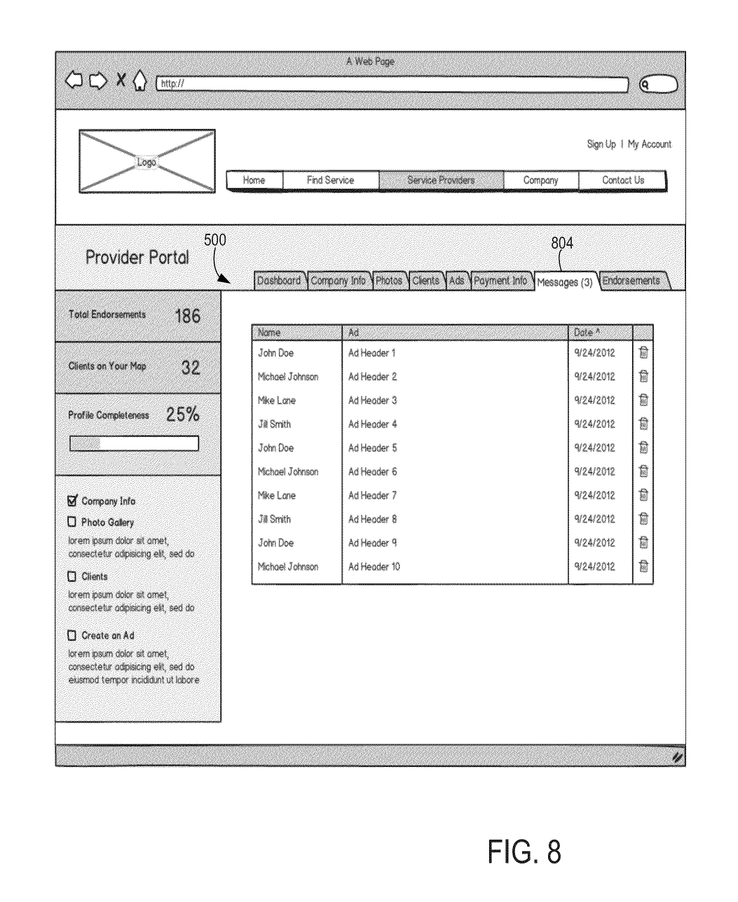

FIG. 8 is a schematic view of an embodiment of the user interface including the provider portal screen 500 of FIG. 5 and showing a messages tab 804. The messages tab 804 may display a list of email messages that have been sent to the service provider from prospective or actual customers. In some examples, the particular ad header that was presented to each customer in the search results delivered to that customer is also displayed with the customer's message.

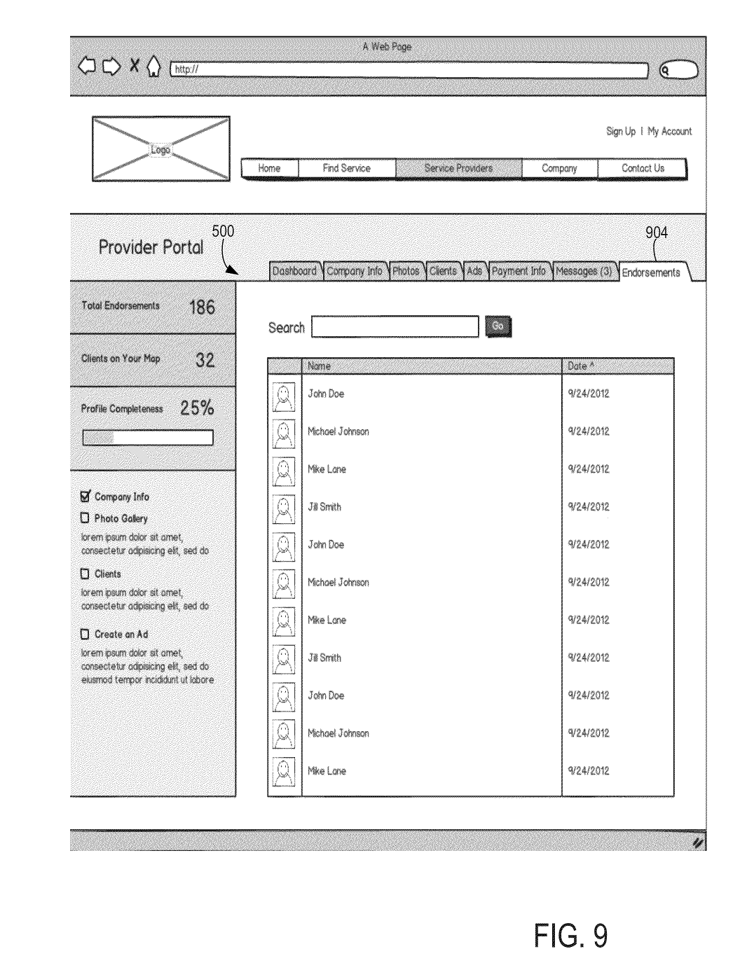

FIG. 9 is a schematic view of an embodiment of the user interface including the provider portal 500 of FIG. 5 and showing an endorsements tab 904. The endorsements tab may display a list of current and previous customers of the service provider and/or other endorsers who have an endorsement connection with the service provider. In some examples, the name of each endorser may be a selectable link that retrieves and displays additional information regarding that endorser when selected.

In another example, matches may be delivered to users on a proactive or push basis. For example, upon logging in to the matching system 10 a user may be presented with suggested service provider information and/or an activity feed that shows activities of others in the user's network or neighbors of the user. In one example, a user may be presented with a service provider profile that indicates that 4 of the user's friends have recently endorsed this service provider. In this manner, service provider information may be pushed to the user based on activities of neighbors, friends and other social network connections of the requester.

In another example, a targeted ad for the matching service provided by matching system 10 may be served to a user of the matching service who is not logged into the service, a first-degree social network connection of the user, or a second-degree social network connection of the user. The social network connections of the user may or may not be members of the matching service. In one example, a first-degree social network connection of the user may not be a member of the matching service and may be participating in the social network service. The targeted ad may be served to the first-degree social network connection via the social networking service, and may promote searches for a particular service, such as, for example, nail salon services. When the social network connection traverses the targeted ad and lands on the matching service landing page, the matching system 10 may utilize information gleaned from the social networking service regarding the social network connection, such as connections with members of the matching service and/or a location of the social network connection, to match the social network connection with one or more service providers. Search results including the one or more service providers may then be provided to the social network connection via the matching service landing page.

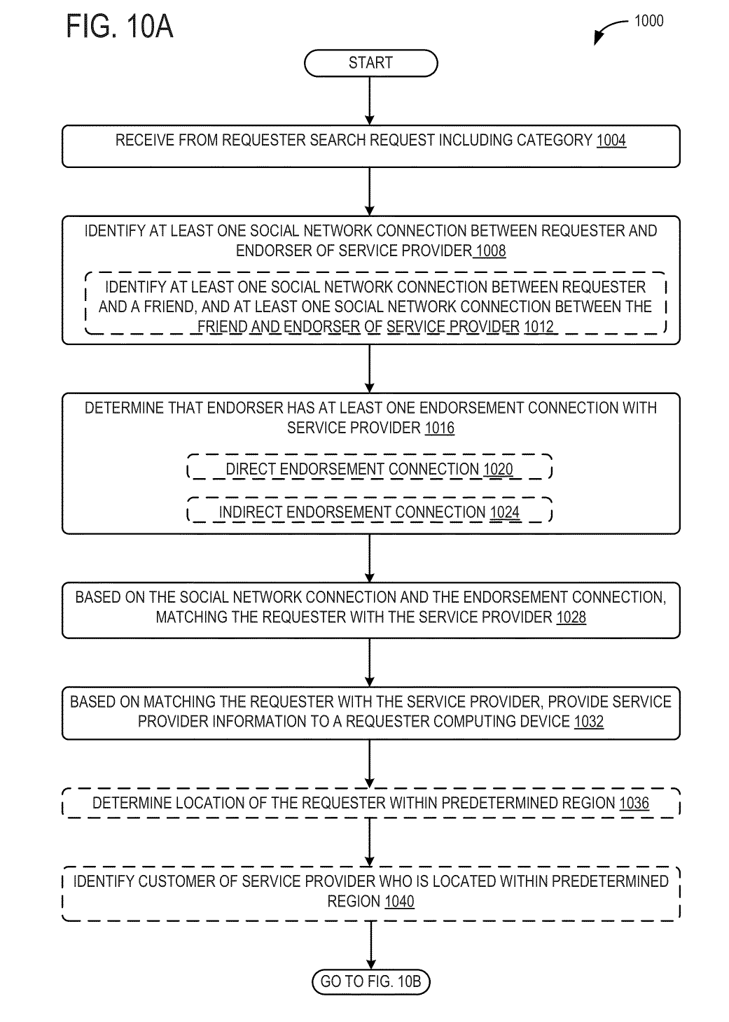

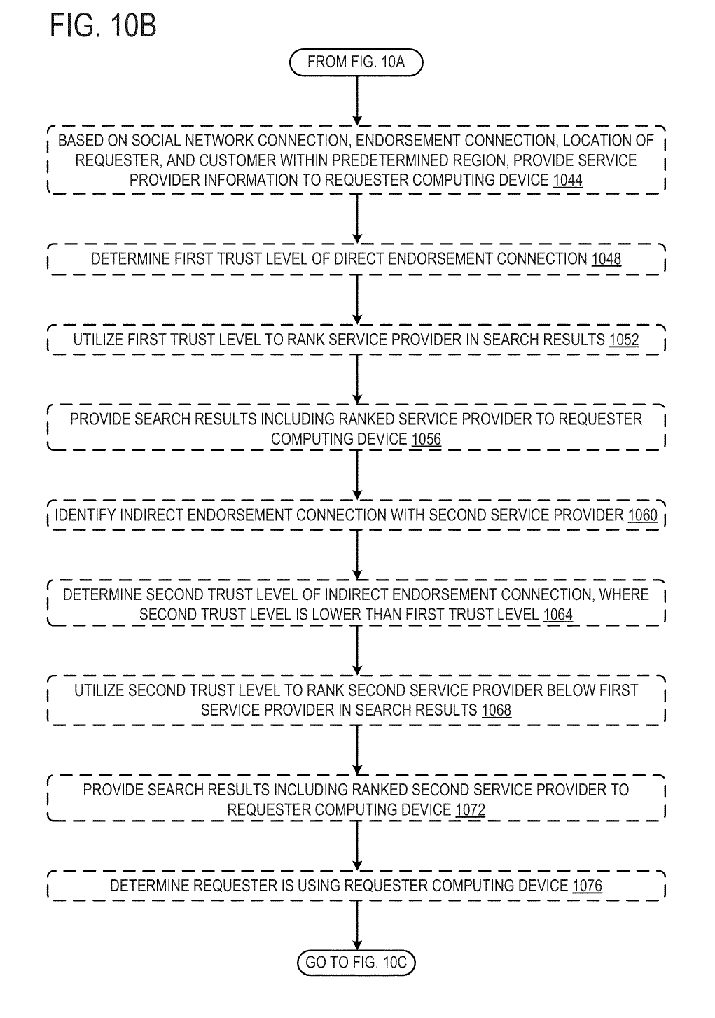

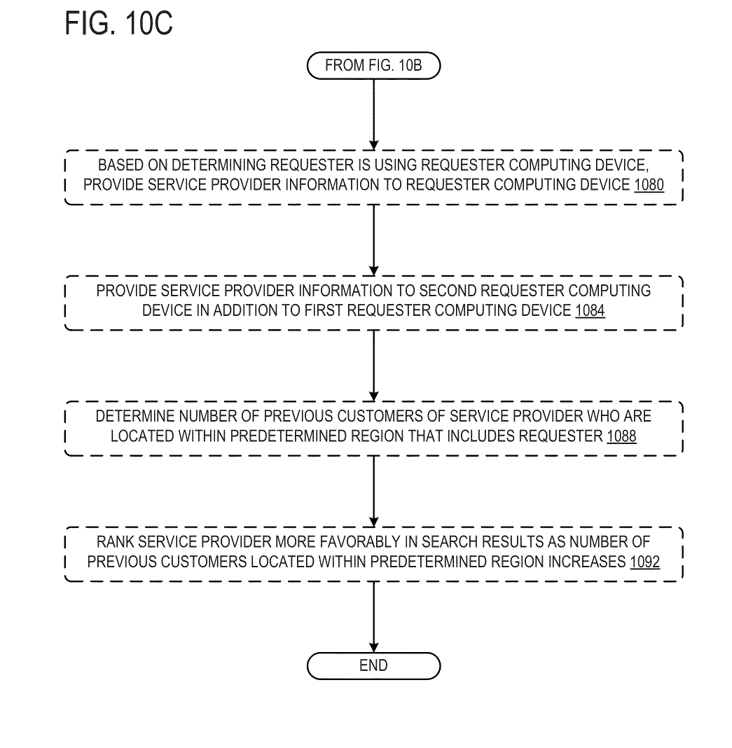

FIGS. 10A, 10B and 10C illustrate a flow chart of a method 1000 for matching a requester with a service provider according to an embodiment of the present disclosure. The following description of method 1000 is provided with reference to the software and hardware components of the matching system 10 described above and shown in FIGS. 1-9. It will be appreciated that method 1000 may also be performed in other contexts using other suitable hardware and software components.

With reference to FIG. 10A, at 1004 the method 1000 includes receiving from a requester a search request including a category. At 1008 the method 1000 includes identifying at least one social network connection between the requester and an endorser of the service provider. In one example, at 1012 the method 1000 may additionally or alternatively include identifying at least one social network connection between the requester and a friend, and identifying at least one social network connection between the friend and the endorser of the service provider.

At 1016 the method 1000 includes determining that the endorser has at least one endorsement connection with the service provider. At 1020 the endorsement connection may be a direct endorsement connection. At 1024 the endorsement connection may be an indirect endorsement connection. At 1028 the method 1000 includes, based on the at least one social network connection and the at least one endorsement connection, matching the requester with the service provider. At 1032 the method 1000 includes, based on matching the requester with the service provider, providing service provider information to a requester computing device that is associated with the requester.

In one example, at 1036 the method 1000 may additionally or alternatively include determining a location of the requester within a predetermined region. At 1040 the method 1000 may additionally or alternatively include identifying at least one customer of the service provider who is located within the predetermined region. With reference now to FIG. 10B, at 1044 the method 1000 may additionally or alternatively include, based on the at least one social network connection, the at least one endorsement connection, the location of the requester, and the identification of the at least one customer located within the predetermined region, matching the requester with the service provider.

At 1048 the method 1000 may additionally or alternatively include determining a first trust level of a direct endorsement connection. At 1052 the method 1000 may additionally or alternatively include utilizing the first trust level to rank the service provider in search results generated by the matching system in response to the search request. At 1056 the method 1000 may additionally or alternatively include providing the search results including the ranked service provider to the requester computing device. At 1060 the method 1000 may additionally or alternatively include identifying an indirect endorsement connection with a second service provider, wherein the indirect endorsement connection is provided by the endorser to a social network or other online service.

At 1064 the method 1000 may additionally or alternatively include determining a second trust level of the indirect endorsement connection, wherein the second trust level is lower than the first trust level. At 1068 the method 1000 may additionally or alternatively include utilizing the second trust level to rank the second service provider below the first service provider in the search results. At 1072 the method 1000 may additionally or alternatively include providing the search results including the ranked second service provider to the requester computing device.

At 1076 the method 1000 may additionally or alternatively include determining that the requester is using a requester computing device. With reference now to FIG. 10C, at 1080 the method 1000 may additionally or alternatively include, based on determining that the requester is using the requester computing device, providing the service provider information to the requester computing device. At 1084 the method 1000 may additionally or alternatively include providing the service provider information to a second requester computing device in addition to a first requester computing device.

At 1088 the method 1000 may additionally or alternatively include determining a number of previous customers of the service provider who are located within a predetermined region that includes the requester. At 1092 the method 1000 may additionally or alternatively include ranking the service provider more favorably in search results generated by the matching system as the number of previous customers located within the predetermined region increases.

It will be appreciated that method 1000 is provided by way of example and is not meant to be limiting. Therefore, it is to be understood that method 1000 may include additional and/or alternative steps than those illustrated in FIGS. 10A, 10B and 10C. Further, it is to be understood that method 1000 may be performed in any suitable order. Further still, it is to be understood that one or more steps may be omitted from method 1000 without departing from the scope of this disclosure.

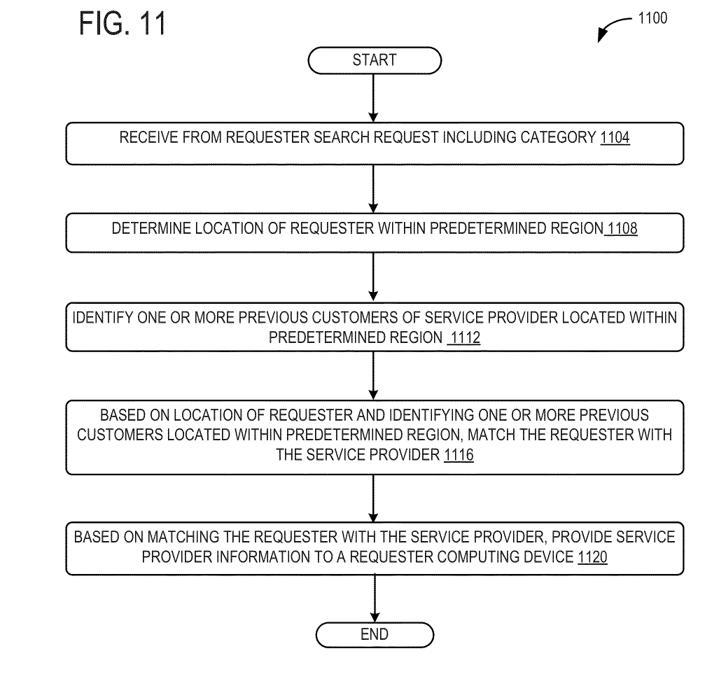

FIG. 11 illustrates a flow chart of a method 1100 for matching a requester with a service provider according to another embodiment of the present disclosure. The following description of method 1100 is provided with reference to the software and hardware components of the matching system 10 described above and shown in FIGS. 1-9. It will be appreciated that method 1100 may also be performed in other contexts using other suitable hardware and software components.

With reference to FIG. 11, at 1104 the method 1100 includes receiving from the requester a search request including a category. At 1108 the method 1100 includes determining a location of the requester within a predetermined region. At 1112 the method 1100 includes identifying that one or more previous customers of the service provider who are located within the predetermined region. At 1116 the method 1100 includes, based on the location of the requester and identifying the one or more previous customers located within the predetermined region, matching the requester with the service provider. At 1120 the method 1100 includes, based on matching the requester with the service provider, providing service provider information corresponding to the service provider to a requester computing device.

It will be appreciated that method 1100 is provided by way of example and is not meant to be limiting. Therefore, it is to be understood that method 1100 may include additional and/or alternative steps than those illustrated in FIG. 11. Further, it is to be understood that method 1100 may be performed in any suitable order. Further still, it is to be understood that one or more steps may be omitted from method 1100 without departing from the scope of this disclosure.

FIG. 12 schematically shows a nonlimiting embodiment of a computing system 1200 that may perform one or more of the above described methods and processes. Matching computing device 22, tablet 54, mobile phone 58, and notebook 62 may take the form of computing system 1200. Computing system 1200 is shown in simplified form. It is to be understood that virtually any computer architecture may be used without departing from the scope of this disclosure. In different embodiments, computing system 1200 may take the form of a mainframe computer, server computer, desktop computer, laptop computer, tablet computer, home entertainment computer, network computing device, mobile computing device, mobile communication device, gaming device, etc.

As shown in FIG. 12, computing system 1200 includes a logic subsystem 1204 and a storage subsystem 1208. Computing system 1200 may optionally include a display subsystem 1212, a communication subsystem 1216, an input subsystem 1220 and/or other subsystems and components not shown in FIG. 12. Computing system 1200 may also include computer readable media, with the computer readable media including computer readable storage media and computer readable communication media. Computing system 1200 may also optionally include other user input devices such as keyboards, mice, game controllers, and/or touch screens, for example. Further, in some embodiments the methods and processes described herein may be implemented as a computer application, computer service, computer API, computer library, and/or other computer program product in a computing system that includes one or more computers.

Logic subsystem 1204 may include one or more physical devices configured to execute one or more instructions. For example, the logic subsystem 1204 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 1204 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 1208 may include one or more physical, persistent devices configured to hold data and/or instructions executable by the logic subsystem 1204 to implement the herein described methods and processes. When such methods and processes are implemented, the state of storage subsystem 1208 may be transformed (e.g., to hold different data).

Storage subsystem 1208 may include removable media and/or built-in devices. Storage subsystem 1208 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 1208 may include devices with one or more of the following characteristics: volatile, nonvolatile, dynamic, static, read/write, read-only, random access, sequential access, location addressable, file addressable, and content addressable.

In some embodiments, aspects of logic subsystem 1204 and storage subsystem 1208 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 12 also shows an aspect of the storage subsystem 1208 in the form of removable computer readable storage media 1224, which may be used to store data and/or instructions executable to implement the methods and processes described herein. Removable computer-readable storage media 1224 may take the form of CDs, DVDs, HD-DVDs, Blu-Ray Discs, EEPROMs, and/or floppy disks, among others.

It is to be appreciated that storage subsystem 1208 includes one or more physical, persistent devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 1212 may be used to present a visual representation of data held by storage subsystem 1208. As the above described methods and processes change the data held by the storage subsystem 1208, and thus transform the state of the storage subsystem, the state of the display subsystem 1212 may likewise be transformed to visually represent changes in the underlying data. The display subsystem 1212 may include one or more display devices utilizing virtually any type of technology. Such display devices may be combined with logic subsystem 1204 and/or storage subsystem 1208 in a shared enclosure, or such display devices may be peripheral display devices. For example, the matching program 26 may be configured to display the matching system GUI and example screens discussed above on such display devices via the display subsystem 1212.

When included, communication subsystem 1216 may be configured to communicatively couple computing system 1200 with one or more networks and/or one or more other computing devices. Communication subsystem 1216 may include wired and/or wireless communication devices compatible with one or more different communication protocols. As nonlimiting examples, the communication subsystem 1216 may be configured for communication via a wireless telephone network, a wireless local area network, a wired local area network, a wireless wide area network, a wired wide area network, etc. In some embodiments, the communication subsystem may allow computing system 1200 to send and/or receive messages to and/or from other devices via a network such as the Internet.

When included, input subsystem 1220 may comprise or interface with one or more sensors or user-input devices such as a touch screen, gesture input detection device, voice recognizer, inertial measurement unit, keyboard, mouse or game controller. In some embodiments, the input subsystem 1220 may comprise or interface with selected natural user input (NUI) componentry.

The term “program” may be used to describe an aspect of the matching system 10 that is implemented to perform one or more particular functions. In some cases, such a program may be instantiated via logic subsystem 1204 executing instructions held by storage subsystem 1208. It is to be understood that different programs may be instantiated from the same application, service, code block, object, library, routine, API, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

Additionally, it will also be appreciated that one or more aspects of the various functions and methods described above as performed by the matching program 26 may be performed by a program resident on one or more other computing devices, such as the tablet computer 54, mobile phone 58, and/or notebook computer 62 described above.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a matching computing device implementing a matching system, a method for matching a requester with a service provider that provides services in a category, the method comprising:
receiving from the requester a search request including the category;
identifying at least one social network connection between the requester and an endorser of the service provider;
determining that the endorser has at least one endorsement connection with the service provider;
based on the at least one social network connection and the at least one endorsement connection, matching the requester with the service provider; and
based on matching the requester with the service provider, providing service provider information corresponding to the service provider to a requester computing device.

2. The method of claim 1, wherein identifying at least one social network connection further comprises:
identifying at least one social network connection between the requester and a friend of the requester; and
identifying at least one social network connection between the friend and the endorser of the service provider.

3. The method of claim 1, further comprising:
determining a location of the requester within a predetermined region;
identifying at least one customer of the service provider who is located within the predetermined region; and
based on the at least one social network connection, the at least one endorsement connection, the location of the requester, and the identification of the at least one customer located within the predetermined region, providing the service provider information to the requester computing device.

4. The method of claim 1, wherein the endorsement connection is a direct endorsement connection that is provided by the endorser to the matching system.

5. The method of claim 4, further comprising:
determining a first trust level of the direct endorsement connection;
utilizing the first trust level to rank the service provider in search results generated by the matching system in response to the search request; and
providing the search results including the ranked service provider to the requester computing device.

6. The method of claim 5, wherein the service provider is a first service provider, the method further comprising:
identifying an indirect endorsement connection with a second service provider, wherein the indirect endorsement connection is provided by the endorser to a social network or other online service;
determining a second trust level of the indirect endorsement connection, wherein the second trust level is lower than the first trust level;
utilizing the second trust level to rank the second service provider below the first service provider in the search results; and
providing the search results including the ranked second service provider to the requester computing device.

7. The method of claim 1, wherein the endorsement connection is an indirect endorsement connection that is provided by the endorser to a social network or other online service.

8. The method of claim 1, further comprising:
determining that the requester is using the requester computing device, and
based on determining that the requester is using the requester computing device, providing the service provider information to the requester computing device.

9. The method of claim 8, wherein the requester computing device is a first requester computing device, the method further comprising providing the service provider information to a second requester computing device in addition to the first requester computing device.

10. The method of claim 1, further comprising:
determining a number of previous customers of the service provider who are located within a predetermined region that includes the requester; and
ranking the service provider more favorably in search results generated by the matching system as the number of previous customers located within the predetermined region increases.

11. A matching system for matching a requester with a service provider that provides services in a category, the matching system comprising:
a matching program comprising instructions stored in a mass storage of the matching system, the matching program configured to:
receive from the requester a search request including the category;
identify at least one social network connection between the requester and an endorser of the service provider;
determine that the endorser has at least one endorsement connection with the service provider;
based on the at least one social network connection and the at least one endorsement connection, match the requester with the service provider; and
based on matching the requester with the service provider, provide service provider information corresponding to the service provider to a requester computing device.

12. The matching system of claim 11, wherein identifying the at least one social network connection further comprises identifying at least one social network connection between the requester and a friend of the requester, and identifying at least one social network connection between the friend and the endorser of the service provider.

13. The matching system of claim 11, wherein the matching program is further configured to:
determine a location of the requester within a predetermined region;
identify at least one customer of the service provider who is located within the predetermined region; and
based on the at least one social network connection, the at least one endorsement connection, the location of the requester, and the identification of the at least one customer located within the predetermined region, provide the service provider information to the requester computing device.

14. The matching system of claim 11, wherein the endorsement connection is a direct endorsement connection that is provided by the endorser to the matching system.

15. The matching system of claim 14, wherein the matching program is further configured to:
determine a first trust level of the direct endorsement connection;
utilize the first trust level to rank the service provider in search results generated in response to the search request; and
provide the ranked search results including the service provider information to the requester computing device.

16. The matching system of claim 15, wherein the service provider is a first service provider, the matching program further configured to:
identify an indirect endorsement connection with a second service provider, wherein the indirect endorsement connection is provided by the endorser to a social network or other online service;
determine a second trust level of the indirect endorsement connection, wherein the second trust level is lower than the first trust level;
utilize the second trust level to rank the second service provider below the first service provider in the search results; and
provide the search results including the ranked second service provider to the requester computing device.

17. The matching system of claim 11, wherein the matching program is further configured to:
determine that the requester is using the requester computing device, and
based on determining that the requester is using the requester computing device, provide the service provider information to the requester computing device.

18. The matching system of claim 17, wherein the requester computing device is a first requester computing device, and the matching program is further configured to provide the service provider information to a second requester computing device in addition to the first requester computing device.

19. The matching system of claim 11, wherein the matching program is further configured to:
determine a number of previous customers of the service provider who are located within a predetermined region that includes the requester; and
rank the service provider more favorably in search results generated by the matching system as the number of previous customers located within the predetermined region increases.

20. In a matching computing device implementing a matching system, a method for matching a requester with a service provider that provides services in a category, the method comprising:
receiving from the requester a search request including the category;
determining a location of the requester within a predetermined region;
identifying that one or more previous customers of the service provider are located within the predetermined region;
based on identifying the one or more previous customers located within the predetermined region, matching the requester with the service provider;
based on matching the requester with the service provider, providing service provider information corresponding to the service provider to a requester computing device.
